(19) United States
(12) Patent Application Publication
(10) Pub. No.: US 2014/0279022 A1
(43) Pub. Date: Sep. 18, 2014

(54) METHOD AND APPARATUS FOR PROVIDING CONTENT UNITS DURING APPLICATION USE

(71) Applicant: Commagere Ventures, Inc., East Palo Alto, CA (US)

(72) Inventor: Blake COMMAGERE, East Palo Alto, CA (US)

(21) Appl. No.: 13/797,245

(22) Filed: Mar. 12, 2013

(51) Int. Cl. G06Q 30/02

(52) U.S. Cl. CPC G06Q 30/0277
USPC 705/14.64; 705/14.72; 705/14.73

(57) ABSTRACT

A method for producing approved content units for an application. The method can include receiving a new content unit from a content provider, approving the new content unit and forming a list of approved content units, wherein the list of approved content units includes at least the new content unit, and wherein each approved content unit for the application can be integrated within the application during real-time use. In addition, the method can include receiving a request from a client library of the application for the list of approved content units for placement within the application during real-time use, and transmitting to the client library a list of approved content units and, for each of the approved content units, associated data for placement within the application.

### FIELD OF THE INVENTION

This invention relates generally to the field of content for applications, such as advertising during on-line games.

### BACKGROUND

Advertisers advertise in a number of different ways for on-line experiences. For instance, many websites user banner advertisements or pop-up advertisements. These types of advertisements can be distracting to the user and can, at times, have low click-through rates.

On-line gaming has become increasingly popular over time. A variety of types of games exist that include user interaction and participation over time. Some of these games are games of luck, but others are games of skill. The increasing popularity of these games has led to opportunities for advertisers.

A need exists for a method and apparatus for advertising during on-line applications, including games.

### SUMMARY OF INVENTION

In accordance with the disclosed subject matter, structures and methods for providing content units for use in applications are provided. The applications can be games, and the content units can be advertisements.

According to one embodiment, a method is provided for producing approved content units for an application. The method can include receiving a new content unit from a content provider, wherein the new content unit is for use in at least the application. The method can also include approving the new content unit and forming a list of approved content units, wherein the list of approved content units includes at least the new content unit, and wherein each approved content unit for the application can be integrated within the application during real-time use, and wherein at least one approved content unit allows for interaction by a user within the application. In addition, the method can include receiving a request from a client library of the application for the list of approved content units for placement within the application during real-time use, and transmitting to the client library a list of approved content units and, for each of the approved content units, associated data for placement within the application during real-time use. As an example, the application can be an interactive game, and the content units can be advertisements. The steps set forth above can, for instance, be performed within a server that runs a service.

Another embodiment is a method for integrating approved content units into an application. In this embodiment, the method can be performed by a client device that contains a client library. The method can include transmitting a request from a client library of the application to a service for a list of approved content units for placement within the application during real-time use of the application. The approved content units can be received from one or more content providers at the service and approved at the service for use in at least the application to form the list of approved content units. The method can also include receiving at the client library from the service the list of approved content units and, for each of the approved content units, associated data for placement within the application during real-time use. In addition, the method can include caching the list of approved content units and associated data on a client device having the application and client library for later use and using the client library to integrate at least one of the approved content units within the application during real-time use.

Yet another embodiment is a method for previewing content units within an application. This embodiment of the invention can be performed by, for example, a device operated by an application developer or a developer of content units. In this embodiment, the method can include receiving at a service a new content unit, where the content unit is for use in at least the application, and where the content unit can be integrated within the application during real-time use and allows for interaction by a user within the application. The method can also include receiving at the service a request from a library for previewing the new content unit within the application and transmitting from the service to the library a link that allows the launching of a version of the application that is integrated with the library to load the new content unit for previewing within the application during real-time use.

### BRIEF DESCRIPTION OF THE DRAWING

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other embodiments as well.

FIG. 1 is a block diagram that shows a networked electronic system in accordance with one embodiment of the invention;

FIG. 2 is a block diagram that shows greater detail of the client device 10, publisher device 20, or service device 30 from FIG. 1;

FIG. 3 shows a flow of data between the devices of FIG. 1 according to one embodiment of the invention;

FIG. 4a shows a game that contains an area for a generic sign according to one use of the system of FIG. 1;

FIG. 4b shows a game with the generic sign of FIG. 4a replaced by a specific sign;

FIG. 5 shows a flow of data between the devices of FIG. 1 according to a second embodiment of the invention; and

FIG. 6 shows a flow of data between the devices of FIG. 1 according to a third embodiment of the invention.

### DETAILED DESCRIPTION

One embodiment of the invention relates generally to a service that can substantially simplify the process of dynamically replacing or creating objects and providing additional metadata within an application or web page. In addition, in some embodiments, the service can provide statistic tracking of user behavior before, during, and after a given object from the system has been created or replaced.

In one embodiment, the present invention relates to a method and system that can be used to provide content units to an application. The application can exist, for example, on a client device, such as a smartphone, and the content units can exist on a server. The application can be, for example, an interactive game, and the content units can be, for example, advertisements that can allow for dynamic interaction during the game. The system can work by allowing the client device to request content units from the server. In response, the server can provide approved content units and associated data to the client device so that the client device can display the content units. In addition, according to some embodiments of the invention, creators of applications and/or content units can preview how content units will appear in a live version of an application during the development process.

The embodiments of the invention set forth herein can be implemented using software/program code to perform the described functions. The embodiments may, for example, use a machine readable medium configured to cause the machine/processor to execute the methods in the manners described herein.

FIG. 1 is a block diagram that shows a networked electronic system in accordance with one embodiment of the invention. In this embodiment, the system can include a client library 15, a server library 25, and a service device 30. As shown in FIG. 1, the client library 15 can reside on a client device 10 that can run an application 12. Similarly, the server library 25 can reside on a publisher device 25 that can run an application or web browser 22. The service 30 can run on a server device. In use, the client device 10 can be a user device that runs an application for interaction by the user. The client library 15 can be used by the application to perform the functionality described herein, and the client library 15 can also be used by application developers during the development process. The server library 25 can be used by the creators of content units for development purposes. Finally, the service 30 can interact with the client library 15 and the server library 25 during use to perform the functionality described herein for the service 30.

The libraries 15, 25 described herein can be in a variety of forms that allow for ease in interfacing and communicating with the service 30. Each library can, for example, include an API. Such an API can be of any type known in the art, including an ActionScript-based version to support flash-based games, an Objective C-based version for iOS support, a Java-based version for Android support, or a JavaScript-based version for HTML5-based applications. Additional types of APIs could also be used within the scope of the invention. Each type of API could have different function calls, but each functions as an interface that allows client applications to retrieve content units from the service 30 and to perform the other functions described herein.

Although FIG. 1 shows only a single client 10 and a single publisher device 20, multiple client devices and multiple publisher devices can be used within the scope of the invention. For instance, each player of an electronic game can use a separate client device 10. In addition, each provider of content units can use a separate publisher device 20. Finally, although only a single service 30 is shown in FIG. 1, multiple devices can be used to provide this service.

As shown in FIG. 1, a communications network 50 connects the client device 10, the publisher device 20, and the service device 30. The communication network 50 can include the Internet, a cellular network, a telephone network, a computer network, a packet switching network, a line switching network, a local area network (LAN), a wide area network (WAN), a global area network, or any number of private networks that can be referred to as an Intranet. Such networks may be implemented with any number of hardware and software components, transmission media and network protocols. FIG. 1 shows the communications network 50 as individual links; however, the network 50 can include the multiple interconnected networks listed above.

The client device 10 contains a client library 15 that can make requests to the service 30 as described herein. As described above, in brief, the client device 10 can be a user device that runs an application for interaction by the user. The client library 15 can be used by the application to perform some or all the functionality described herein for the client, and the client library 15 can also be used by application developers during the development process. The client device 10 can be any type of computing device, such as a personal computer, a mobile computer, a mobile electronic device, a personal electronic device, an electronic or computer system, computer server, or a network of computer servers and systems, that sends signals through the communications network 50 to the other devices connected thereto. In one preferred embodiment, the client device 10 can be a mobile electronic device.

The publisher device 20 with its server library 25 can also make requests to the service 30 as described herein. The publisher device 20 can be used by the creators of content units for development purposes, and the server library 25 can aid in this process as described herein. The publisher device 20 may be any number of electronic devices capable of receiving and processing data received over the communications network 50, such as a personal computer, a mobile computer, a mobile electronic device, a personal electronic device, an electronic or computer system, computer server, or a network of computer servers and systems, that sends signals through communications network 50 to the other devices connected thereto. In one preferred embodiment, the publisher device 20 can be a computer system or computer server. The publisher device 20 and client device 10 can be located at a common remote site, at different sites, and can be coupled together. In addition, it is possible within the scope of the invention to use the publisher device 20 to perform the functions of both the publisher device 20 and the client device 10 as described herein.

The service 30 can respond to the requests from the client library 15 and the server library 25 and can be used to provide many of the services described herein with respect to content units. It may also be at a remote site from both the client device 10 and the publisher device 20, but it may also be located at a common site with one or both of the other devices shown in FIG. 1. Like the publisher device 20, the service device 30 may be any number of electronic devices capable of receiving and processing data received over the communications network 50, such as a personal computer, a mobile computer, a mobile electronic device, a personal electronic device, an electronic or computer system, computer server, or a network of computer servers and systems, that sends signals through communications network 50 to the other devices connected thereto. In one preferred embodiment, the service device 30 can be a computer server.

FIG. 2 is a block diagram that shows greater detail of the client device 10, publisher device 20, or service 30 from FIG. 1. At a high level, each of these entities 10, 20, 30 can be a computer system. The computer system can include a processor 201, an input/output component 202, and a memory/storage module 203. Additional components can also be used for any of entities 10, 20, 30.

Processor 201 can be configured to be a central processing unit or application processing unit in the embodiment of FIGS. 1 and 2. Processor 201 might also be implemented in hardware using an application specific integrated circuit (ASIC), programmable logic array (PLA), field programmable gate array (FPGA), or any other integrated circuit or circuit structure that can perform the functionality of entities 10, 20, 30 from FIG. 1.

Input/output component 202 may comprise a specialized combination of circuitry (such as ports, interfaces, wireless antennas) and software (such as drivers) capable of handling the receiving signals and image, video, or audio data from any one of the entities 10, 20, 30.

Memory/storage module 203 can include cache memory, flash memory, a magnetic disk drive, an optical drive, a programmable read-only memory (PROM), a read-only memory (ROM), or any other memory or combination of memories. The memory/storage module 203, therefore, can be a non-transitory computer readable medium of a variety of types known to those skilled in the art.

In accordance with some embodiments, the memory/storage module 203 may also be sufficient to store the libraries 15, 25 of the client device 10 or publisher device 20 and data described herein. In addition, a memory/storage module 204 of the service 30 can store code that performs the functions of the of the service 30 described herein, as well as data associated therewith. In accordance with some embodiments of the invention, the processor 201 may be capable of executing a software program that allows the functions described herein for each of the entities 10, 20, 30 to be performed.

As described above, three primary components in FIG. 1 include the client library 15, the server library 25, and the service 30. In order to implement the service within an application, an application publisher can embed the client library 15 into its application 12. The application 12 can then be loaded onto a computing device, such as client device 10 shown in FIG. 1. As an example, the application publisher can be a provider of online games or the like.

During use, the service 30 can be used to provide approved content units to the application 12 on the client device 10. Before being provided to end users of the client devices 10 during use, the content units can be developed by the publisher device(s) 20 and server library(ies) 25. After the content units are provided by the server library(ies) 25 to the service 30, these content units can be “approved” by one or more entities described herein for use within an application 12. In addition, after applications are developed and submitted to the service 30 (applications can, for instance, be developed through use of client device(s) 10), these applications can be “approved” for use with certain content units. For example, the application developers can approve the use of certain content units within their application(s). Likewise, the publishers of content units can approve the use of those content units within certain applications. Thus, some combination of entities, perhaps also including the operator of the service 30 or a third party clearinghouse, can approve content units for use with certain applications. Thus, the service 30 can form a list of approved content units for each application. These are content units that can be used within the application 12, and these content units might be, for instance, verified as working properly within the application 12 at issue. Each new content unit that is approved for use with the application 12 can be added to the list of approved content units for that application 12. In addition, content units might can, in some embodiments, be approved only for use with certain parts or areas of the application 12, and a list of approved content units can be specific to that part or area of the application 12.

In some embodiments, the approved content units can be integrated within the application 12 during real-time use by the client device(s) 10. For example, the content units can be for interactive integration within the application 12 during real-time use, not simply for viewing within the application 12. For example, if the application 12 is a game and the content units are advertisements, the advertisements can be designed for interactive integration into the game. This could, for example, allow a user to interact with an advertisement in a way that can alter the game. This could include, for instance, the display of a particular brand of soda (as the content unit), and the application 12 could change course based on this interaction. For example, if a player of the game drinks a soda, that player may have greater energy or capabilities, or the player may need to use a restroom.

As another example of a content unit that allows for dynamic interaction within an application, if a content unit is an advertisement of a particular type of shoe, and the application is a game that includes a product placement for the shoes during use, the player, upon selection of the shoes, can become faster so that the player can play the game more quickly. In other words, the selection or interaction with the content unit can dynamically alter the game.

Other types of dynamic interaction with content units within an application 12 are also possible within the scope of the invention. As another example, a content unit can provide a window inside a game or other application that allows additional content for following the content unit (such as a product where the content unit is an advertisement) on Twitter or through the use of a coupon. The content unit can provide interaction in several ways, such as, for example: (1) driving traffic to another web page or application (including, for example, a web page for making a product purchase); (2) placing something on the device, such as a cookie, that allows for advertisement retargeting (for example, if the user clicks on a content unit that is a shoe and the cookie tracked this, a service could show the user advertisements for shoes on the web or shoe billboards in other applications); (3) allowing the user to follow a brand on Twitter, Facebook, or other social media channels; and/or (4) providing an email address or other method of contact (such as a cell phone or address) for a coupon, discount, or free product from the brand of an advertisement. In this embodiment, the interaction with the content unit by the user allows the user to do something different with the content unit aside from merely playing the game or using the application 12.

Each content unit can include a set of data that describes an asset that makes up a piece in the application 12. For example, where the content unit is an advertisement in an application that is a game, the content unit can be an in-game object that has been branded for a particular product brand. For each such content unit, the client library 15 can store (after download from the service 30) the content unit that the game should use. The content units can be, for example, images such as png files, swf files for Flash-based games, YouTube videos, or mp3 files for sound. Additional types of content units can also be used, and multiple types of content can be used within the same content unit.

According to some embodiments of the invention, the creators of applications and/or content units can preview how content units will appear in a live version of an application during the development process. This allows the developers of applications and/or content units to view content units within applications live during use in order to ensure that those content units appear and function properly within the applications during use.

The following disclosure describes embodiments of the invention for use in real-time use of the application with content units, then in connection with preview of applications with content units, and finally in connection with preview of content units within an application.

Real-Time Use of Application with Content Units

FIG. 3 shows a flow of data between the devices of FIG. 1 according to one embodiment of the invention. This embodiment uses the service 30 to import approved content units into the application 12 during real-time use of the application 12. In this embodiment, upon initialization, in step 1a the client library 15 requests approved content units from the service 30 (assuming content units have already been added and approved for use as described above).

When the service 30 receives this request, it returns to the client library 15 in step 2a a list of approved content units and, for each approved content unit, its associated data. This list of approved content units in step 2a is accessible by the application 12 via the client library 15 to replace or create objects within the application 12. For devices that are not guaranteed 100% network connectivity, the content unit data is flushed to local storage on the client device 10 and used when network connectivity is not available. When the application is opened, if there is no network connection available to request the latest approved content units, the client library 15 can use the stored content units. When a connection later becomes available, new content units can be requested from the service 30. As such, the approved content units can be cached to local storage so that the client library 15 can use the content units for the application even when network connectivity is not available.

As described thus far in connection with FIG. 3, this embodiment allows for the use of the application 12 with content units approved for use even if the client device 10 is not connected to the network 50. The application 12 of the client device 10 can then use the client library 15 (after it has received the approved content units) to display one or more of the content units within real-time use of the application 12. In addition, the content units can be used for interaction within the game so that the course of the game or outcome of the game can be partially or fully determined by interaction with the content units. In this embodiment, the content units are not simple banner or pop-up ads for display, but instead are units that are fully integrated into the game.

In some embodiments of the invention, logging data related to the client device's 10 end user behavior and interactions with any of these approved content units is regularly queued up and sent to the service 30. FIG. 3 shows this step of sending log data from the client library 15 to the service 30 in step 3a. In the event there is no network connectivity, this logging data can be flushed to local storage and then sent to the service 30 the next time network connectivity is available. Statistic reporting can allow, for example, advertisers to see trends and relevant data about how users view and interact with content units within the application 12. The client library 15 and service 30 can provide a number of function calls to report relevant interaction events.

Step 4a of FIG. 3 shows that a new content unit can be added by using the application or web browser 22 that uses the server library 25 on the publisher device 20 to create a new content unit. This new content unit can be sent to the service 30 as shown in FIG. 3 in step 4a. The new content unit can then be approved for use within an application as described above.

The embodiment described in connection with FIG. 3 can be used for a variety of implementations. First, it can be used in game product placement (as part of the gaming experience or a background element of the game) with associated metadata describing characteristics of the product and/or how the game world is changed to react to the product placement. In this embodiment, for instance, the approved units can be advertisements, advertisement information, or product placement information. During use, for instance, the application 12 on the client device 10 can be a game. The game can be an interactive game that has devices or components therein that can be updated or replaced with approved content units. For instance, a billboard within the game can be updated to be a billboard for a particular product, service, or company, and interaction with the billboard can alter the course of the game. The content unit display can be done by the application 12 using the client library 15 to request (step 1a in FIG. 3) a list of approved units from the service 30 and by having the service 30 return a list of approved units (step 2a). The log data (step 3a) can be used to monitor interactions with the objects having the approved content units within the game. In addition, new approved content units that can be used within the game can be added by a publisher (i.e., an advertiser) through the publisher device 20. The advertiser can do so by using the server library 25 or its application or web browser 22 to interact with the service 30 to add new content units (here, advertisements) (step 4a). In this embodiment, the content units can be advertisements that contain one or more of graphic objects, videos, and audio information, and that allow for interaction by the user.

Second, the embodiment of FIG. 3 can be used for native advertising implementations for a music application in order to drive purchases of the latest song(s) or album(s). In this embodiment, the application 12 of the client device 10 can be a music application, and this music application can have the client library 15 embedded therein. In addition, the approved content units in this embodiment can include, for example, audio information.

Third, the embodiment of FIG. 3 can be used for A/B testing of different content to examine user preferences of content and/or user interface or UX elements. For example, the system could be used for a game that would like to test two different pictures and prices for an item in the game and see which drives the most user purchases. Alternatively, the system could be used by a music application to determine which album to promote to an audience or even to promote different albums to different audiences based on demographic data. Further, the system could be used to optimize various prices and pieces for content to different demographics. As an example, the system could be used to charge a higher price to U.S. players than to non-U.S. players or show different pictures that are more appealing to particular classes of users, such as men or younger users. Multiple content units and associated data could be used for each placement, thus allowing an application to have hundreds or thousands of pieces of content and sets of data, each optimized for a particular viewing demographic.

FIGS. 4a and 4b illustrate the use of the embodiment of FIG. 3 where the application 12 on the client device 10 is the game 400 shown in FIGS. 4a and 4b. The game 400 in FIGS. 4a and 4b is an interactive game. FIG. 4a shows that the game 400 contains an area for a sign 401 to identify a store. The store can be a feature that comes up interactively while a user is playing the game 400. In FIG. 4a, this sign 401 contains a general description of a café (Café Du Smug). After the game 400 uses its client library 15 to request approved units from the service 30 (step 1a of FIG. 3) and the service 30 responds with a list of approved units (step 2a of FIG. 3), one of the approved units can be displayed in the game 400.

FIG. 4b shows that the generic sign 401 of FIG. 4a has been replaced by an advertisement 403; in this embodiment, an advertisement 403 for Starbucks, making the store shown in the game 400 a Starbucks store. When the user interacts with the Starbucks store in this embodiment, the interaction can alter the course of the game in a variety of ways—for instance, the user might be presented with certain types of coffee specific to Starbucks, the user might enter the Starbucks and have the game experience and feel change to that of a Starbucks store, or the user might receive a greater amount of energy due to drinking one or more cups of coffee. Numerous other types of interactions of users with the content units are possible within the scope of the invention.

The request, list and log data described above in steps 1a, 2a, and 3a of FIG. 3 can be implemented in a number of different ways. For example, a developer can add an application as a supported application with the service 30. This can include, for instance, creating a custom application ID for the application within the service 30. The service 30 can then approve the application for use within the service 30.

An application developer can then create locations within the application that allow for the use of one or more content units. Each location in an application that can host a custom content unit can be called a placement or supported placement. A placement can be created for each unique content unit location within the application. For example, if there are two billboards in the application and the application developer wishes to be able to host a unique advertisement on each, a placement will need to be created for each and they will be referenced individually by the unique placement names.

The application developer can add a supported placement by using a user interface for the service 30 to select the application ID, select a feature to add a new supported placement, and then add information regarding the supported placement. This information can include, for example, (1) a unique name for each supported placement within the application, (2) the type of asset that can be used for the placement in the application, (3) the placement type that can be used to describe what the placement within the application will do with a developer's content unit, (4) any requirement assets for the placement, such as a requirement of being a 100×100 PNG file, (5) a general description of the placement, which can include any relevant information that helps providers of content units understand how the asset can be used in the application, (6) supported options for the placement, which can include allowing click-through URLs and caption text, and (7) a start date for when the placement will be available for use. Some or all of these types of information can be used within the scope of the invention, and various other types of additional information can also be used.

After a supported placement has been created, it can be made available to content user developers. The placement name can be used as the key for calls to the client library 15 or server library 15 (also referred to as a SDK or API, depending on the context). As an example, the following exemplary line of code could retrieve a preloaded advertisement asset with the placement name “ExamplePlacement”:
MSAdUnitView* adUnit=[Mediaspike getAd:@“ExamplePlacement”]

When the application 12 on the client device 10 loads the part of the application 12 having the placement, the application 12 can use the client library 15 to make a call to the service 30 to request the content units to be used for the placement as described above in connection with step 1a of FIG. 3. If there is an approved content unit associated with the placement, the approved content unit can be returned from the service 30 (step 2a of FIG. 3) and initialized on the client device 10 for use within the application to populate the placement.

Referring again to FIG. 3, the request in step 1a can ask for the active or approved content units for the application by using the application ID. The return in step 2a can be, for instance, a JSON object containing information on the current active or approved content units, including the ID of each content unit and the serving URL. The client library 15 can parse this information and prefetch the content units.

The log information in step 3a of FIG. 3 can report interaction statistics to the service 30. As an example, parameters that can be reported can include (1) the ID of the content unit, (2) the number of times since the last update that the user purchased the content unit in the application, (3) a click-through count of the number of times since the last update that the user clicked on the content unit resulting in a click-through to an external URL, (4) a count of the number of times since the last update that the user has consumed the content unit in the application, (5) a count of the number of times since the last update that the user has interacted with the content unit (for any interactions that don't fit in other categories), (6) a count of the number of times since the last update that the user has received the content unit as a gift from another user, (7) a count of the number of times since the last update that the user has sold the content unit in the application, (8) a count of the number of times since the last update that the user has sent the content unit as a gift to another user, and/or (9) a list of how many times the user has viewed the content unit since the last update as well as optionally providing the amount of time the content unit was viewed for each occurrence.

### Application Preview

In one embodiment, under typical circumstances, the service 30 will serve content units to client devices 10 for use in a live application only when the application is active and the content unit has been approved for use within the application. It can help to allow previewing or testing of content units within applications for this reason.

FIG. 5 shows a flow of data between the devices of FIG. 1 according to a second embodiment of the invention. In this embodiment, the owner or operator of an application 12 or a content unit can load content and metadata related to that content into the service 30 and then launch an application or webpage 12 that is integrated with the software development kit (SDK) (shown as the client library 15 in FIG. 5) in order to preview the content and metadata on the live application. This can allow, for instance, the owner or operator of an application to test how a content unit from the service 30 will appear within the application during use.

This is accomplished by passing data that identifies the supported placement and example content, which in turn is parsed by the service 30. For instance, referring to FIG. 5, in step 1b a content provider can use the server library 25 to provide one or more content units to the service 30. In this embodiment, the publisher device 20 having the server library 25 can be a device used by a content unit developer, and the client device 10 can be a device used by an application developer.

In step 2b of FIG. 5 the application developer can use the SDK 15 to send a request to the service 30 to preview the application 12 with a specific content unit. In other words, a server request can made that retrieves the content and metadata and an object is either created or replaced by the SDK 15 with the new content. This request can include, for example, an ID of the content unit that the user desires to preview, which can be, for example, a content unit created by the user or a content unit submitted to the service 30 to be associated with a supported placement for an application.

Once the new content unit has been created and the request has been sent in step 1b, the application containing the specific content unit of interest can be previewed by clicking a link generated by the service 30 that allows the client device 10 to launch an application that is integrated with the client library 15 and that passes that application data that will instruct the client library 15 to load the new content unit that has not yet been approved. As shown in step 3b of FIG. 5, the service 30 can send a link to the client library 15 to allow the application developer to preview the content unit. This allows the application developer to interact with the application 12 and determine how the new content unit appears within the application 12.

For example, if the client device 10 is a computer connected to the internet, the link delivered in step 3b can be a formatted URL. When clicked by the user, the URL will take the user to a web page that has the application, and it will pass some parameters to the client library 15 so that it knows how to read the content unit. This approach can also be used if the client device 10 is a mobile device, such as a smartphone.

In another embodiment, if the client device 10 is a mobile device such as a smart phone, the link can be an application URL with parameters that open an app on the mobile device and interact with the content library 15 to provide the app with the content unit of interest. This link can be provided to the mobile device in a number of ways, including by email.

The embodiment described in connection with FIG. 5 can be used for a variety of implementations. First, this embodiment can be used for the preview of a game product placement within a live application. This can be, for example, used as part of the gaming experience or as a background element of the game. The placement can be viewed with associated metadata describing characteristics of the product and/or how the game world is changed to react to the product placement. This allows the developer of the game product to determine how advertisement units may appear within the game during live use and determine if the content unit is properly set up to work with the game. As an example, if the content provider is an advertiser, the game developer might want to make sure the advertiser's advertisement appears correctly within the game and can be interacted in the proper manner by the user during real-time use. This allows the game developer to determine, in advance, if an advertisement appears properly within the game. This can allow the application developer (e.g., game developer) to approve the use of a content unit within the application during use.

Second, the embodiment of FIG. 5 can be used to preview native advertising implementations within a live music application that seeks to drive purchases of recent song(s) or album(s). In this embodiment, the application 12 of the client device 10 can be a music application, and this music application can have the client library 15 embedded therein. In addition, the approved content units in this embodiment can include, for example, audio information.

Third, the embodiment of FIG. 5 can be used to preview A/B testing of different content on a live application before exposing it to users, similar to the embodiment described above in connection with FIG. 3.

### Content Unit Preview

FIG. 6 shows a flow of data between the devices of FIG. 1 according to a third embodiment of the invention. In this embodiment, a third party content provider, such as an advertiser, can load content and metadata related to that content into the service 30 and then launch an application in order to preview the content and metadata on the live application. This can allow, for instance, the third party to test how its units/content will appear within certain applications during use. This can allow the content unit developer (e.g., advertiser) to approve the use of a content unit within an application during use.

This is accomplished by passing data that identifies the supported placement and example content which in turn is parsed by the SDK or server library 25. For instance, referring to FIG. 6, in step 1c a content provider can use the server library 25 to provide one or more content units to the service 30. In this embodiment, the publisher device 20 can be used by the content provider.

In step 2c, the content provider can use the server library 25 to send a request to the service 30 to preview one or more of the content units within a specific application. In other words, a server request can made that retrieves the content and metadata and an object is either created or replaced by the server library 25 with the new content.

Once the new content unit has been created and the request has been sent in steps 1c and 2c, the application containing the specific content unit of interest can be previewed by clicking a link generated by the service 30 that allows the publisher device 20 to launch an application that is integrated with the server library 25 and that passes that application data that will instruct the server library 25 to load the new content unit that is not yet been approved. As shown in step 3c of FIG. 6, the service 30 can send a link to the server library 25 to allow the content provider to preview the content unit. This allows the content provider to interact with the application and determine how the new content unit appears within the application during real-time use.

As in connection with FIG. 5, the link delivered in step 3c can be, for example, either a formatted URL or an application URL.

The embodiment described in connection with FIG. 6 can be used for a variety of implementations. First, this embodiment can be used for the preview of a game product placement within a live application. This can be, for example, used as part of the gaming experience or as a background element of the game. The placement can be viewed with associated metadata describing characteristics of the product and/or how the game world is changed to react to the product placement. This allows the creator of the content unit, such as an advertiser, to determine how the advertisement units may appear within the game during live use.

Second, the embodiment of FIG. 6 can be used to preview native advertising implementations within a live music application that seeks to drive purchases of the recent song(s) or album(s). In this embodiment, the application 12 of the client device 10 can be a music application, and this music application can have the client library 15 embedded therein. In addition, the approved content units in this embodiment can include, for example, audio information. This allows the creator of the audio unit, such as an advertiser, to determine how the advertisement unit sounds during live use.

Third, the embodiment of FIG. 6 can be used to preview A/B testing of different content on a live application before exposing it to users, similar to the embodiment described above in connection with FIG. 3.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for producing approved content units for an application comprising:
(a) receiving a new content unit from a content provider, wherein the content is for use in at least the application;
(b) approving the new content unit and forming a list of approved content units, wherein the list of approved content units includes at least the new content unit, and wherein each approved content unit for the application can be integrated within the application during real-time use, and wherein at least one approved content unit allows for interaction by a user within the application;
(c) receiving a request from a client library of the application for the list of approved content units for placement within the application during real-time use; and
(d) transmitting to the client library a list of approved content units and, for each of the approved content units, associated data for placement within the application during real-time use.

2. The method of claim 1, further comprising receiving log data from the client library, wherein the log data includes information on interactions with at least one of the approved content units through the application.

3. The method of claim 1, wherein the content units are advertisements, wherein the application is an interactive game, and wherein the advertisements are for placement within the interactive game during real-time use.

4. The method of claim 1, wherein the client library and the application reside on a mobile device.

5. The method of claim 1, wherein the at least one approved content unit, upon interaction by the user within the application, dynamically changes at least one feature of the application.

6. The method of claim 1, wherein the client library resides on a client device, and wherein the client device is a mobile device.

7. The method of claim 1, wherein the request is from a service library residing on a content provider.

8. The method of claim 1, wherein the step of approving the content unit can be performed by one or more of an application developer and a content unit developer.

9. The method of claim 1, further comprising allowing a developer to preview the new content unit within a live version of the application prior to approving the content unit.

10. A method for integrating approved content units into an application comprising:
(a) transmitting a request from a client library of the application to a service for a list of approved content units for placement within the application during real-time use of the application, wherein the approved content units are received from one or more content providers at the service and approved at the service for use in at least the application to form the list of approved content units;
(b) receiving at the client library from the service the list of approved content units and, for each of the approved content units, associated data for placement within the application during real-time use;
(c) caching the list of approved content units and associated data on a client device having the application and client library for later use; and
(d) using the client library to integrate at least one of the approved content units within the application during real-time use.

11. The method of claim 10, further comprising transmitting log data from the client library, wherein the log data includes information on interactions with at least one of the approved content units through the application.

12. The method of claim 10, wherein the content units are advertisements, wherein the application is an interactive game, and wherein the advertisements are for placement within the interactive game during real-time use.

13. The method of claim 10, wherein the client library and the application reside on a mobile device.

14. The method of claim 10, wherein at least one approved content unit, upon interaction by the user within the application, dynamically changes at least one feature of the application.

15. The method of claim 10, further comprising allowing a developer to preview the new content unit within a live version of the application prior to approving the content unit.

16. A method for previewing content units within an application comprising:
(a) receiving at a service a new content unit, wherein the content unit is for use in at least the application, and wherein the content unit can be integrated within the application during real-time use and allows for interaction by a user within the application;
(b) receiving at the service a request from a library for previewing the new content unit within the application; and
(c) transmitting from the service to the library a link that allows the launching of a version of the application that is integrated with the library to load the new content unit for previewing within the application during real-time use.

17. The method of claim 16, wherein the request is from a client library residing on a client device.

18. The method of claim 16, wherein the request is from a service library residing on a content provider.

19. The method of claim 16, wherein the new content unit is an advertisement, wherein the application is an interactive game, and wherein the advertisement is for placement within the interactive game during real-time use.

20. The method of claim 19, wherein the advertisement, upon interaction by the user within the interactive game, dynamically changes at least one feature of the interactive game.
